(19) United States
(12) Patent Application Publication
(10) Pub. No.: US 2011/0207897 A1
(43) Pub. Date: Aug. 25, 2011

(54) IONOMERS FOR IMPROVED COMPRESSION SET IN CERTAIN COPOLYMERS

(75) Inventors: Keith R. Mccrba, Walnut Creek, CA (US); Robert S. Ward, Lafayette, CA (US); Yuan Tian, Alameda, CA (US); Jim Yang, Berkeley, CA (US); Keith Kurczewski, Baywood, CA (US)

(73) Assignee: DSM IP ASSETS B.V., Heerlen (NL)

(21) Appl. No.: 12/809,217

(22) PCT Filed: Dec. 17, 2008
(86) PCT No.: PCT/US08/87138

§ 371 Date: Feb. 22, 2011

Related U.S. Application Data
(60) Provisional application No. 61/015,399, filed on Dec. 20, 2007.

(51) Int. Cl. C08G 77/458; C08G 18/87

(52) U.S. Cl. 525/459; 525/452; 525/453

(57) ABSTRACT

Block copolymer having improved compression set comprising 40-98 wt-% soft segment, 1.9-20 wt-% hard segment, and 0.05-3 wt-% monofunctional ionic endgroups. The incorporation of ionomers into diisocyanate-based thermoplastic polyurethane materials greatly improves compression set with little impact on the overall TPU formulation. A typical formulation for making the block copolymer contains 84.2% polydimethylsiloxane, 12.9% diisocyanate, 2.9% diamine chain extender, 0.15% sodium 2-[bis(2-hydroxyethyl)amino]ethylsulfonate, and 0.05% isethionic acid. The polymeric material may be configured, for instance, as a contact lens, prosthetic spinal nucleus, orthopedic bearing surface, gasket, or sealant.

### FIELD OF THE INVENTION

The present invention relates to novel polyurethane block copolymers, and to methods of preparing them. The novel polymers of the present invention are characterized by improved compression set. These materials are thermoprocessable and can provide compression set properties required for applications such as gaskets, seals, or orthopedic devices.

### BACKGROUND OF THE INVENTION

In general, thermoplastic urethane (TPU) material marketed for gaskets and seals use aromatic diisocyanates to maximize intermolecular forces between the hard segments, which lead to improved compression set properties. However, aliphatic diisocyanates with improved compression set are desirable for their optical properties such as transparency and stable, reproducible indices of refraction. It is therefore important to improve the intermolecular forces between polymer changes through virtual physical or ionic crosslinks of aliphatic materials.

Sulfonated ionomers may be used to improve the high temperature mechanical properties of various polymers. Properties of note include: improved compression set, increased solvent resistance, and enhanced toughness. The improved properties result from the interaction of the ionic groups, which strengthens the intermolecular forces between polymer chains. In essence, a physical crosslink is created between the ionic groups within the polymer chain. If the ionomer concentration is high enough, a secondary glass transition temperature T_{g} may be observed that is associated with the ionomers. At high temperatures these ionic interactions can be disassociated and the material will flow and is processable. At lower temperatures, the ionic groups will reform the associated interaction and act as crosslinks between polymer chains. These crosslinks are therefore thermally reversible. Conventionally, ionomers are incorporated within the polymer chain. A typical ionic crosslinker used for this purpose is sodium 2-[bis(2-hydroxyethyl)amino]ethylsulfonate (sometimes referred to as “BES”).

### SUMMARY OF THE INVENTION

The present invention provides a block copolymer having improved compression set. The block copolymer of this invention is made up of 40 to 98 wt-% soft segment, 1.9 to 20 wt-% hard segment, and 0.05 to 3 wt-% monofunctional ionic endgroups. This incorporation of ionomers into, for instance, diisocyanate-based thermoplastic polyurethane materials, greatly improves their compression set while having very little impact on the overall thermoplastic polyurethane formulation. The polymeric materials provided by this invention may be configured, for instance, as contact lenses, prosthetic spinal nucleuses, orthopedic bearing surfaces, gaskets, or sealants.

In the block copolymer having improved compression set of the present invention, the soft segment may be made from an aliphatic polyol (e.g., a linear, branched, or graft polyarylene, polyalkylene, or polyalkenylene oxide, or a random or block copolymer thereof). The soft segment may alternatively be made from a polycarbonate polyol, a hydroxyl-terminated silicone, or a random or block copolymer thereof with a polyalkylene oxide or a linear or branched polyalkenyl or polyalkylene polyol. Finally, the soft segment may be made up from mixtures of any of the foregoing radicals. A preferred group of soft segments are made from compounds having the formula

NH₂(CH₂)₃—Si(CH₃)₂—O—[Si(CH₃)₂—O]ₙ—Si(CH₃)₂—(CH₂)₃NH₂

wherein n=0 to 500. Such compounds are commercially available, for instance, from Wacker-Chemie GmbH of Munich, Germany. Typical specific products are designated as PDMS 3345, PDMS 1218, and PDMS 130160.

In the block copolymer having improved compression set of the present invention, the hard segment may be made from an alkyl diisocyanate, an arylalkyldiisocyanate, an alkyl-cycloalkyl diisocyanate, an alkylaryl diisocyanate, a cycloalkyl diisocyanate, an aryl diisocyanate, or a cycloalkylaryl diisocyanate. These hard segment precursors may be further substituted with oxygen moieties. Mixtures of these hard segment precursors may be employed to make the block copolymers having improved compression set of this invention.

Normally, a chain extender is employed during synthesis of the hard segment of the block copolymer having improved compression set provided by the present invention. Such chain extenders may be selected from alkylene, cycloalkylene, and arylene diols, triols, tetraalcohols, pentaalcohols, and alkylene diamines, as well as mixtures thereof. In a preferred embodiment of the present invention, up to 50% of the chain extender is made from a compound having the formula A-(CH)ₘ—N(BD)ₙ-(CH)ₒ-A wherein: A is either OH or NH₂; m, n, and o are integers ranging from 1 to 8; B is an ionic functional group such as carboxylate, sulfonate, or phosphonate; and D is an alkali metal.

In accordance with the present invention, the block copolymer having improved compression set of this invention contains an ionic end group of the formula A-(CH₂)n-(BD)ₘ wherein: A is either OH or NH₂; n is an integer of 1 to 18; B is an ionic functional group such as carboxylate, sulfonate, or phosphonate; m is 1, 2, or 3; and D is an alkali metal.

Another embodiment of the present invention is a method of making a polymer having improved compression set, by the steps of: providing a reaction vessel containing an inert solvent, rapidly adding to said solvent in said reaction vessel, in the absence of catalyst, an amino-terminated polydimethylsiloxane, an aliphatic diisocyanate, an ionic surface-modifying endgroup, and, optionally, an alkylene diol chain extender, at ambient temperature, and removing the resulting polymer from the reaction vessel within 60 minutes of adding the reactants thereto. In this method, 0.05% to 0.5% sodium 2-hydroxyethylsulfonate, for instance, may be added to the solvent in the reaction vessel in order to provide a resulting polymer with ionomeric surface-modifying endgroups.

The polymeric material having improved compression set provided by the invention described herein may be configured—without limitation—as a contact lens, prosthetic spinal nucleus, orthopedic bearing surface, gasket, or sealant.

In an embodiment of the present invention, sulfonated endgroups are incorporated at the end of polymer chains. A typical ionomer which can be used to introduce an ionomeric surface-modifying endgroup (SME) into a polymer in accordance with the present invention is sodium 2-hydroxyethylsulfonate, also known as isethionic acid sodium salt. Using this novel approach, a smaller concentration of SMEs is required over a sulfonated chain extender to observe similar enhanced mechanical properties. The sulfonated SME can also be used along with a sulfonated chain extender to further improve compression set.

### DETAILED DESCRIPTION OF THE INVENTION

### Block Copolymers

The present invention provides block copolymers, which include a soft segment, a diisocyanate-based hard segment, the hard segment also including an alkylene diamine chain extender and a multifunctional chain extender which provides delayed crosslinking. The block copolymers of this invention are characterized by improved compression set.

The soft segment used in the preparation of the block copolymers of the invention may be a polyfunctional aliphatic polyol, or a polyfunctional aliphatic or aromatic amine such as are commonly used for the preparation of polyurethanes. The molecular weight of the soft segment is typically about 200 to 1,000,000, and preferably about 400 to 9,000.

Aliphatic polyol soft segment components may be selected from linear and branched polyalkylene and polyalkenyl oxides, random and block copolymers thereof, polycarbonate polyols, hydroxyl-terminated silicones, random and block copolymers thereof with polyalkylene oxides, linear and branched polyalkenyl and polyalkylene polyols, and mixtures thereof.

Examples of polyols that are suitable for use in the present invention are polyethylene oxides, polypropyleneoxides, polytetramethylene oxides, random or block polypropylene oxide-polyethylene oxide copolymers, various ethyleneoxide-terminated polyols, random or block polytetramethylene oxide-polyethylene oxide copolymers, polycarbonate diols and triols, multifunctional hydroxyalkyl- or amine-terminated silicones, random or block silicone-polyethyleneoxide copolymers, polybutadiene diols and triols, polyisobutylene diols and triols, and mixtures thereof.

Amine soft segment components may be selected from the group consisting of amine-terminated homologues of the above polyols, including but not limited to polyamine-terminated alkylene oxides and random and block copolymers thereof, polyamine-terminated silicones, random and block copolymers thereof with polyalkylene oxides and mixtures thereof.

Examples of the amines that are suitable for use in the present invention are multifunctional amine-terminated polytetramethylene oxides, multifunctional amine terminated polyethylene oxides, random or block multifunctional amine terminated polypropylene oxide-polyethylene oxide copolymers, random or block multifunctional amine-terminated polytetramethylene oxide-polyethylene oxide copolymers, multifunctional amine-terminated silicones, random or block amine-terminated silicon polyethylene oxide copolymers and mixtures thereof.

Suitable polyisocyanates for the preparation of the hard segment of the copolymer of the invention are aromatic or aliphatic polyisocyanates. The organic diisocyanates may be selected from the group consisting of alkyl diisocyanates, arylalkyl diisocyanates, cycloalkylalkyl diisocyanates, alkylaryl diisocyanates, cycloalkyl diisocyanates, aryl diisocyanates, cycloalkylaryl diisocyanates, all of which may be further substituted with oxygen, and mixtures thereof.

Examples of suitable polyisocyanates are 4,4′-diphenylmethane diisocyanate, hexamethylene diisocyanate, dicyclohexylmethane diisocyanate, 2,4-toluene diisocyanate, 2,6-toluene diisocyanate, hexamethylene-1,6-diisocyanate, tetramethylene-1,4-diisocyanate, cyclohexane-1,4-diisocyanate, naphthalene-1,5-diisocyanate, diphenylmethane-4,4′-diisocyanate, xylylene diisocyanate, dicyclohexylmethane-4,4′-diisocyanate, 1,4-benzene diisocyanate, 3,3′-dimethoxy-4,4′-diphenyl diisocyanate, m-phenylene diisocyanate, isophorone diisocyanate (IPDI), polymethylene polyphenyl diisocyanate, 4,4′-biphenylene diisocyanate, 4-isocyanatocyclohexyl-4′-isocyanate, and mixtures thereof.

The chain extender of the hard segment used in the preparation of the copolymers of the invention may be an aliphatic polyol or an aliphatic or aromatic polyamine such as those known for preparing polyurethanes.

The polyol for the hard segment may be preferably selected from the group consisting of alkylene, cycloalkylene and arylene diols, triols, tetraalcohols, and pentaalcohols, and mixtures thereof. Examples of polyols suitable for the preparation of the hard segment are 1,4-butanediol, ethylene glycol, 1,6-hexanediol, glycerine, trimethylolpropane, pentaerythritol, 1,4-cyclohexane dimethanol, phenyl diethanolamine, and mixtures thereof, among others. However, other polyols are also suitable.

The diamine of the hard segment may be selected from the group consisting of alkyl, cycloalkyl and aryl amines which may be further substituted with N, O, or halogen, complexes thereof with alkali metal salts, and mixtures thereof. Suitable diamines for preparing the hard segment are p,p′-methylene dianiline and complexes thereof with alkali metal chlorides, bromides, iodides, nitrites and nitrates, 4,4′-methylene-bis(2-chloroaniline), piperazine, 2-methylpiperazine, oxydianiline, hydrazine, ethylenediamine, hexamethylenediamine, xylylenediamine, bis(p-aminocyclohexyl)methane, dimethyl ester of 4,4′-methylenedianthranilic acid, p-phenylenediamine, m-phenylenediamine, 4,4′-methylene bis(2-methoxyaniline), 4,4′-methylene bis(N-methylaniline), 2,4-toluenediamine, 2,6-toluenediamine, benzidine, dichlorobenzidine, 3,3′-dimethylbenzidine, 3,3′-dimethoxybenzidine, diansidine, 1,3-propanediol bis(p-aminobenzoate), isophorone diamine, and mixtures thereof.

The copolymer of the invention may be prepared in a wide range of molecular weights. Molecular weights may range from 5000 to 1,000,000, and preferably from about 10,000 to 100,000.

The preparation of block copolymers is in general well known to persons skilled in the art. Particularly useful disclosures relevant thereto may be found in U.S. Pat. No. 5,428,123, entitled COPOLYMERS AND NON-POROUS, SEMI-PERMEABLE MEMBRANE THEREOF etc., the contents of which are incorporated by reference herein. Also, the incorporation of surface-modifying endgroups is by now well-established technology. A pioneer patent in this field is U.S. Pat. No. 5,589,563, entitled SURFACE-MODIFYING ENDGROUPS FOR BIOMEDICAL POLYMERS. The entire disclosure thereof is expressly incorporated herein by reference.

In a specific bulk synthesis example of the method, 84.2% PDMS 3345, 12.9% IPDI, 2.9% DYTEK A, 0.15% BES, and 0.05% isethionic acid are metered into a twin-screw extruder at 190° C. with a screw speed 200 rpm to produce a block copolymer having improved compression set.

### Compression Set

The permanent deformation remaining after release of a compressive stress is defined as Compression Set. Compression set is expressed as the percentage of the original deflection. Compression set is an important property for elastomers and cushioning materials.

### DEFINITION

In accordance with the present invention, a polymer has “improved compression set” when its compression set can be decreased by at least 5% by aging at 25° C. for 72 hours.

In order to evaluate the compression set of the present formulations, a Compression Set apparatus may be assembled a based on ISO 815. This includes the design and manufacturing of a mold capable of producing samples required in ISO 815. All of the compression set tests reported herein are performed using 25% strain at 70° C. for 22 hours.

The test specimen is compressed for a specified time at a specified temperature. Compression Set is calculated as the percentage of the original deflection after the material is allowed to recover at standard conditions for 30 minutes. Compression set is calculated using the formula: C=[(hₒ−hᵢ)/(hₒ−hₐ)]*100 where hₒ is the original specimen thickness, hᵢ is the specimen thickness after testing, and hₒ is the spacer thickness.

A strain of 25% may be used for testing. Test specimens may be cylindrical disks 29.0 mm in diameter and 12.5 mm in thickness, cut from a slab of the testing material.

Aliphatic diisocyanate-based TPUs are desirable over their aromatic diisocyanate-based counterparts because they do not discolor due to exposure to ultraviolet light. It is known that aromatic diisocyanates provide polyurethane materials with considerably improved compression set properties. Aliphatic isocyanate based TPUs, on the other hand, generally exhibit very poor compression set due to weaker intermolecular forces compared to aromatic isocyanates. The present invention provides a means to increase intermolecular forces within aliphatic hard segments to prevent plastic deformation when the material is under compressive forces. In accordance with the present invention, ionomers can be incorporated into aliphatic TPUs as surface modifying endgroups to improve compression set of the resulting polymers.

In accordance with the present invention, the incorporation of ionomers into aliphatic diisocyanate-based thermoplastic polyurethane materials greatly improves compression set with little impact on the overall TPU formulation. Although this invention focuses on the use of ionomers to improve the compression set of aliphatic polyurethanes, ionomers can also be used to improve compression set in aromatic urethanes.

### EXAMPLES

### Example 1

Two formulations were prepared, as follows:

| Formulation 1A | Formulation 1B |
|---|---|
| (without ionomer) | (with ionomer) |
| 97.54% PDMS 130160 | 97.51% PDMS 130160 |
| 2.44% HMDI | 2.44% HMDI |
| | 0.05% ionomer* |

*sodium 2-hydroxyethylsulfonate (isethionic acid sodium salt)

The polydimethylsiloxane (PDMS 130160) was added to a high-temperature batch reactor held at 190° C. and stirred at 90 rpm. Hexamethylene di-isocyanate (HMDI) was added to polymerize the PDMS 130160. In the case of Formulation 1B, after the HMDI and PDMS 130160 reacted with one another for 5 minutes, the sodium 2-[bis(2-hydroxyethyl)amino]ethylsulfonate ionomer was then added and reaction was allowed to go to completion. The reaction product (polymer) was then drained into a stainless steel pan and the polymer was collected for compression set sample fabrication and testing. The material without ionomer (Formulation 1A) exhibited a compression set of 72%. The material in accordance with the present invention (Formulation 1B) exhibited a compression set of 62%.

### Example 2

Two formulations were prepared, as follows:

| Formulation 2A | Formulation 2B |
|---|---|
| (without ionomer) | (with ionomer) |
| 80.30% PDMS 130160 | 80.14% PDMS 130160 |
| 15.16% HMDI | 15.13% HMDI |
| 4.54% butane diol | 4.42% butane diol |
| | 0.31% ionomer* |

*sodium 2-hydroxyethylsulfonate (isethionic acid sodium salt)

The polydimethylsiloxane (PDMS 130160) was added to a high-temperature batch reactor held at 190° C. and stirred at 90 rpm. Hexamethylene di-isocyanate (HMDI) was added to polymerize the PDMS 130160, and the reaction was allowed to proceed for 5 minutes. Then, the butane diol, and in the case of Formulation 1B, the sodium 2-[bis(2-hydroxyethyl)amino]ethylsulfonate ionomer, was/were added and reaction was allowed to proceed to completion. The reaction product (polymer) was then drained into a stainless steel pan and the polymer was collected for compression set sample fabrication and testing. The material without ionomer (Formulation 2A) had a compression set of 94%. The material in accordance with the present invention (Formulation 2B) had a compression set of 63%.

### Example 3

Two formulations were prepared, as follows:

| Formulation 3A | Formulation 3B |
|---|---|
| (without ionomer) | (with ionomer) |
| 89.79% PDMS 130160 | 89.69% PDMS 130160 |
| 8.16% HMDI | 8.16% HMDI |
| 2.05% butane diol | 1.99% butane diol |
| | 0.16% ionomer* |

*sodium 2-hydroxyethylsulfonate (isethionic acid sodium salt)

The polydimethylsiloxane (PDMS 130160) was added to a high-temperature batch reactor held at 190° C. and stirred at 90 rpm. Hexamethylene di-isocyanate (HMDI) was added to polymerize the PDMS 130160, and the reaction was allowed to proceed for 5 minutes. Then, the butane diol, and in the case of Formulation 1B, the sodium 2-[bis(2-hydroxyethyl)amino]ethylsulfonate ionomer, was/were added and reaction was allowed to proceed to completion. The reaction product (polymer) was then drained into a stainless steel pan and the polymer was collected for compression set sample fabrication and testing. The material without ionomer (Formulation 2A) had a compression set of 100%. The material in accordance with the present invention (Formulation 2B) had a compression set of 75%.

### Concentration of Ionomers

The examples above show that only a small concentration of ionomer is required for a significant improvement in compression set results. Ionomers are incorporated as surface modifying endgroups. Other ionomers may, but need not be, incorporated as either chain extenders. In a TPU formulation, an ionomer such as BES can replace some or all of the chain extender used in the formulation. When using a surface modifying end group ionomer such as isethionic acid, a much smaller concentration can be used due to a decrease in polymer molecular weight at high concentrations. Generally, a surface modifying endgroup ionomer concentration should be limited to below 3% to maintain the physical properties of the TPU.

### Applications

These materials can be used wherever thermoplastic polyurethanes are commonly used, for either medical or industrial applications. In addition, these materials can be used in seal or gasket applications, such as O-rings, window seals, and automotive gaskets. Particularly useful applications of the present transparent polyurethane block copolymers include use as contact lenses, intraocular lenses, and the like.

### Injection Molding of a Gasket

A gasket made from Formulation 1B above is processed using injection molding. The polymer is dried by flowing dry air at 180° F. until the water content is less than 0.01%. The dried polymer is then melted in a Arburg 320C Allrounder injection molder and charged into a cavity mold configured to produce a gasket at 9000 psi. The injection cycle takes 3-10 seconds with a mold temperature of 80° F. As the gasket cools, ionic forces between the ionomer groups form, thereby creating virtual crosslinks which improves compression set of the formed article.

### Compression Molding of a Polymer Block for Downstream Machining.

A prosthetic spinal disk is made from Formulation 3B via compression molding. The polymer made according to Formulation 3B is dried by flowing dry air at 180° F. until the water content is less than 0.01%. The top platen temperature is set at 190 C and the bottom platen is set at 180° C. A clean steel mold is sprayed with Teflon release agent. The steel frame is placed on the base plate and polymer is placed evenly within the frame. The top plate is then placed above the polymer and the entire mold is placed on the lower platen of the compression equipment. Pressure is increased to 6000 pounds until the polymer melts. The pressure is then increased to 19,000 pounds until polymer exits the side of the mold. Pressure is held for another 30 seconds at which time the pressure is relieved and the mold is placed in a bucket of water to cool. The polymer block is then removed from the mold and ready for machining. As the part cools, ionic forces between the ionomer groups will form, creating virtual crosslinks and thereby improving compression set of the formed article. The part is then machined into a prosthetic spinal disk.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed but that the invention includes all equivalent embodiments.

What is claimed is:

1. A block copolymer having improved compression set comprising 40-98 wt % soft segment, 1.9-20 wt % hard segment, and 0.05-3 wt % monofunctional ionic endgroups which provide improved compression set in said block copolymer.

2. The block copolymer of claim 1, wherein said soft segment is made with a compound selected from aliphatic polyols of the group consisting of linear, branched, and graft polyarylene, polyalkylene, and polyalkenylene oxides, random and block copolymers thereof, polycarbonate polyols, hydroxyl-terminated silicones, random and block copolymers thereof with polyalkylene oxides, linear and branched polyalkenyl and polyalkylene polyols, and mixtures thereof.

3. The block copolymer of claim 1, wherein said soft segment is made from
NH₂(CH₂)₃—Si(CH₃)₂'O—[Si(CH₃)₂—O]ₙ—Si(CH₃)₂—CH₂)₃NH₂
wherein n=0 to 500,

4. The block copolymer of claim 1, wherein the diisocyanate in the hard segment is made with a compound selected from the group consisting of alkyl diisocyanates, arylalkyldiisocyanates, alkyl-cycloalkyl diisocyanates, alkylaryl diisocyanates, cycloalkyl diisocyanates, aryl diisocyanates, and cycloalkylaryl diisocyanates, which may be further substituted with oxygen, and mixtures thereof.

5. The block copolymer of claim 4, wherein the hard segment is made from a cycloalkyl diisocyanate.

6. The block copolymer of claim 5, wherein the hard segment comprises isophorone diisocyanate.

7. The block copolymer of claim 1, wherein a chain extender is used to make up the hard segment, said chain extender being selected from the group consisting of alkylene, cycloalkylene, and arylene diols, triols, tetraalcohols, pentaalcohols, alkylene diamines, and mixtures thereof

8. The block copolymer of claim 1, wherein up to 50% of a chain extender used to make up the hard segment is made from a compound having the formula A-(CH)ₘ-N(BD)ₙ-(CH)ₒ-A wherein: A is either OH or NH₂; m, n, and o are integers ranging from 1 to 8; B is an ionic functional group such as carboxylate, sulfonate, or phosphonate; and D is an alkali metal.

9. The block copolymer of claim 1, having an ionic end group of the formula A-(CH₂)n-(BD)ₘ wherein: A is either OH or NH₂; n is an integer of 1 to 18; B is an ionic functional group such as carboxylate, sulfonate, or phosphonate; m is 1, 2, or 3; and D is an alkali metal.

10. A method of making a block copolymer having improved compression set, which method includes the steps of:
providing a reaction vessel containing an inert solvent,
rapidly adding to said solvent in said reaction vessel, in the absence of catalyst, an amino-terminated polydimethylsiloxane, an aliphatic diisocyanate, an ionic surface-modifying endgroup, and, optionally, an alkylene diol chain extender, at ambient temperature, and
removing the resulting polymer from the reaction vessel within 60 minutes of adding the reactants thereto.

11. The method of claim 10, wherein 0.05% to 0.5% sodium 2-hydroxyethylsulfonate is added to the solvent in the reaction vessel in order to provide the resulting polymer with ionomeric surface-modifying endgroups.

12. The method of claim 10, wherein said method is a method for making a polymer having improved compression set by bulk synthesis, which method comprises the step of:
metering into a twin-screw extruder
84.2% PDMS 3345
12.9% IPDI
2.9% DYTEK A
0.15% BES
0.05% isethionic acid
at 190° C. with a screw speed 200 rpm.

13. The polymeric material of claim 1, configured as a contact lens, prosthetic spinal nucleus, orthopedic bearing surface, gasket, or sealant.
